(19) United States
(12) Patent Application Publication
(10) Pub. No.: US 2002/0069219 A1
(43) Pub. Date: Jun. 6, 2002

(54) Method and system for providing online web page reading records

(76) Inventor: Jen-Hwang Weng, Jungli City (TW)

Correspondence Address: DOUGHERTY & TROXELL, 5205 LEESBURG PIKE, SUITE 1404, FALLS CHURCH, VA, 22041, US

(21) Appl. No.: 09/981,797

(22) Filed: Oct. 19, 2001

(30) Foreign Application Priority Data
Dec. 4, 2000 (TW) 89125823

(51) Int. Cl. G06F 17/00

(52) U.S. Cl. 707/501.1; 707/530

(57) ABSTRACT

A method and system for providing online web page reading records allows a plurality of users to use reading record function on a web page. The method includes: displaying a web page content, providing a plurality of reading record function on the web page to match users' requirements, receiving reading records entered by the users through the reading record function on the web page and instantly displaying the related reading records on the web page; and storing users' identification data and the related reading records on the web page made by the users.

### FIELD OF THE INVENTION

The present invention relates to network activities and particularly a method and system for providing online web page reading records.

### BACKGROUND OF THE INVENTION

The rising of the Internet has greatly accelerated information circulation and enriched information contents. Facing the huge amount of data and information, many users are apprehensive or feel overwhelmed. While it is nice to be able to access and retrieve information easily, it also could be baffling to glean and cull the really needed and useful information from the torrents of data flooding the networks. Without proper aids and helps, many users often browse the data hastily on the web site screens without getting intimate feeling and true benefits.

Many content providers offer information on the Internet in an one-way displaying fashion. While some web sites provide the so called two-way interactions, they are generally limited to inquiry function. The retrieved information is still presented in a one-way display format for one way browsing. True two-way interactions are scarce.

From users' viewpoint, the two-way information interaction is usually reflected to behaviors of reading conventional printed publications. For instance, many users have the habit of making marginal notes and remarks on the books, or underlining the key points or deleting some of the contents. These additions can be made directly on the paper or books to become personal supplements which are presented constantly. Hence users have full confidence of the books being read and can search the personal supplements handily. In other words, users have full control and use of the information. However such kind of advantages is still does not exist or is not widely available on the web pages in the presently known Internet applications.

The invention aims at transferring traditional reading behaviors to reading behaviors on the networks. For instance, the actions of making marginal notes and remarks on the books, underlining the key points or deleting some of the contents that many people used to do in traditional reading printed materials can be adapted on the web page through the invention. Moreover, the characteristics of nonlinear and multimedia presentation of computers and networks can be used to hyperlink the web pages to reference files, or adding multimedia objects to the web pages. When implementing the recording of web page reading behavior, related information can be automatically recorded into the system for future reference when the same web page is retrieved again, and original reading records can be restored and presented.

The far reaching and rapid transmission capability of networks is their core value to serve as information transmission tools. From enterprise management perspective, this far reaching and rapid transmission capability of networks allows faster interactions between the enterprise and customers all the time. As a result, enterprises can provide customized services to users and clients more effectively. Taking publication industry as an example, in the past, publishers have little influence on readers' reading behaviors. With the availability of the networks, publishers now can offer complementary and aid function to better meet readers' requirements in addition to the traditional reading behaviors. In other words, the core value of network publications, in addition to the contents, should include reading record function. Under such circumstances, even the published contents have been downloaded unlawfully, readers cannot take full advantages of the reading record function in the offline environments. Hence commercial value of downloaded contents without license or authorization will be diminished. This can help to discourage pirating practices.

### SUMMARY OF THE INVENTION

The primary object of the invention is to provide a web site system and method for recording online web page reading data. The web site system allows a plurality of users through networks to read the web page contents provided by the web site system, and allows the users entering and editing reading records on the web pages. The web site system consists of: a server for linking networks, a database for storing a plurality of web page contents and related reading records and user's data, and a reading record system to offer a plurality of reading record functions on the web pages. The reading record functions are designed and setup based on users' requirements, and include an insert object meant to receive a user's request for inserting an object on the web page and immediately display the inserting object on the web page, a change display format meant to receive user's request for changing a portion of the web page displaying content and immediately display the changed format on the web page, and a recording meant to store user's identification data and user's reading records related to the web pages in the database.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an environment of the invention in use.

FIG. 2 is an architecture diagram of a web site system of the invention.

FIG. 3 is a flow chart of the method of the invention.

FIG. 4 is a flow chart of an insert object means of the invention.

FIG. 5 is a flow chart of a change display format means of the invention.

FIG. 6 is a flow chart for storing user's identification data and user's reading record data related to the web pages.

FIG. 7 is an initial web page panel according to the invention.

FIG. 8 is a web page panel with a user inserting a text object to the initial web page.

FIG. 9 is a web page panel with a user inserting a hyperlink object to the initial web page.

FIG. 10 is a web page panel with a user selecting a portion of text for underline on the initial web page.

FIG. 11 is a web page panel with a user selecting a portion of text for deletion on the initial web page.

FIG. 12 is a web page panel with the user browsing the recorded initial web page.

### DETAILED DESCRIPTION OF THE INVENTION

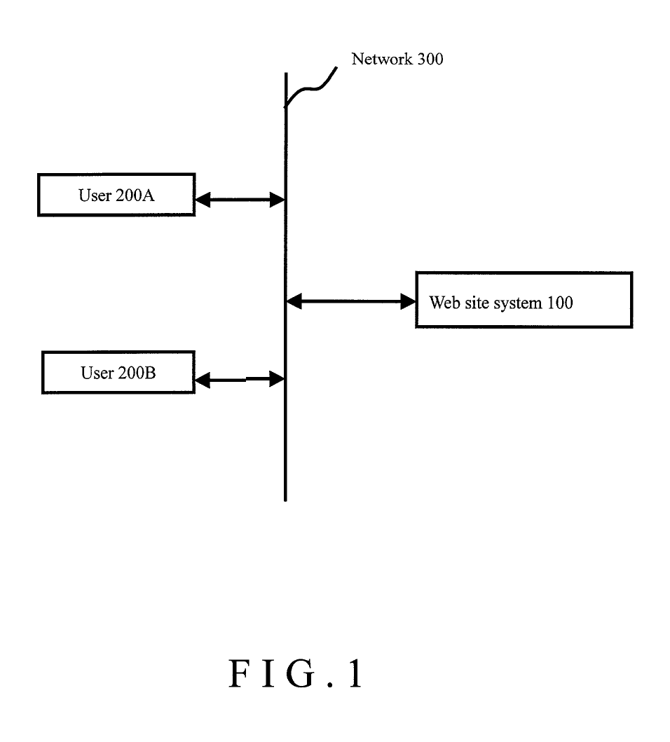

Referring to FIG. 1 for an environment of the invention in use, a plurality of users 200 may link and access to a web site system 100 of the invention through a network 300.

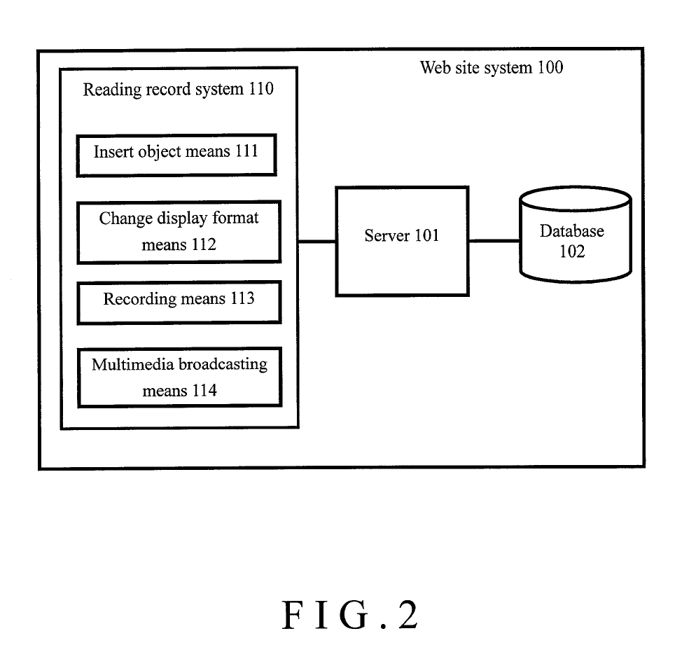

FIG. 2 shows an architecture diagram of the web site system 100 of the invention. The web site system 100 includes:

a server 101 for linking the network 300;

a database 102 for storing a plurality of web page contents and related reading records and users' data;

a reading record system 110 for providing a plurality of reading record function on one web page to match users' 200 requirements. For instance, the function may employ Microsoft's VBscript to edit and download the web page to allow user ends to receive users' requests for performing reading record function and to present the results desired. The reading record function may include: allowing users to enter remarks or insert objects (making marginal notes and remarks, making hyperlink, inserting multimedia objects, etc.), or changing a portion of the displaying contents (underlining key points, adding deletion line, masking a portion of contents, etc.), and immediately displaying the results desired on the web page.

The reading record system 110 includes:

an insert object means 111 for receiving requests from the users 200 to insert objects on the web page and immediately displaying the inserted object on the web page. This means must be downloaded to users' ends;

a change display format means 112 for receiving requests from the users 200 to change a portion of the web page displaying content and immediately displaying the changed format on the web page. This means must be downloaded to users' ends;

a recording means 113 for storing reading data related to the web pages made by the users 200 in the database 102. This means may employ Microsoft's Visual Basic language and Microsoft's ActiveX Data Objects 2.5 Library to generate ActiveX objects. For instance, for a user to mark underlines on web page text, the recording means 113 may record: user's account number, marking time, marking text content including text content object identification, HTML program codes required for underlining the text, etc.

The web site system further includes a multimedia broadcasting means 114. Users 200 may use this feature to insert a multimedia object on the web page (such as audio objects, video objects, etc.) and accepts a practical path to broadcast the contents of the multimedia object. This means can employ Microsoft's Visual Basic language and adapts Lib “winmm.dll” of API (Application Programming Interface) commands to setup ActiveX objects. To broadcast special multimedia objects, matching MCI driver programs are required. This means must be downloaded to users' ends.

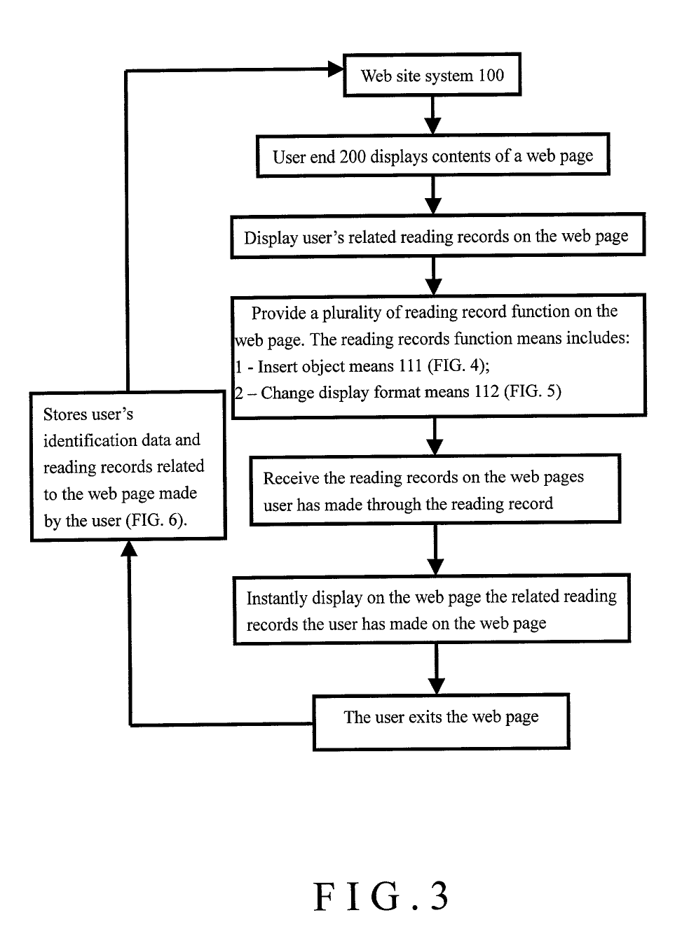

Referring to FIG. 3 for the processes of the method of the invention, the web site system 100 provides users 200 reading record function according to the following steps:

Step A: the web site system 100 displays a web page on a user end 200;

Step B: if the user has previous reading records on the web page, display the reading records related to the web page. The reading records may include: the inserted web page objects which the user has made previously or changed display formats of the web page objects;

Step C: the reading record system provides a plurality of reading record function on the web page. The reading record function means can be grouped in two types:

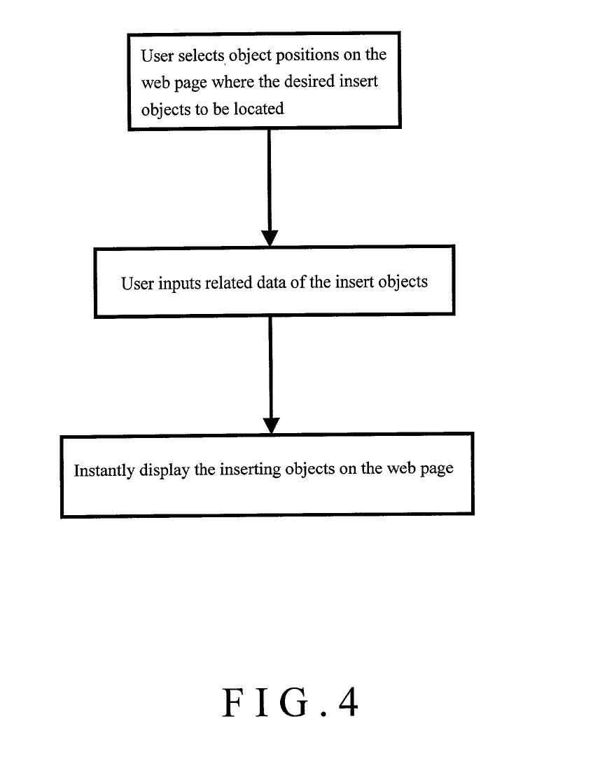

1. Insert object means (FIG. 4),

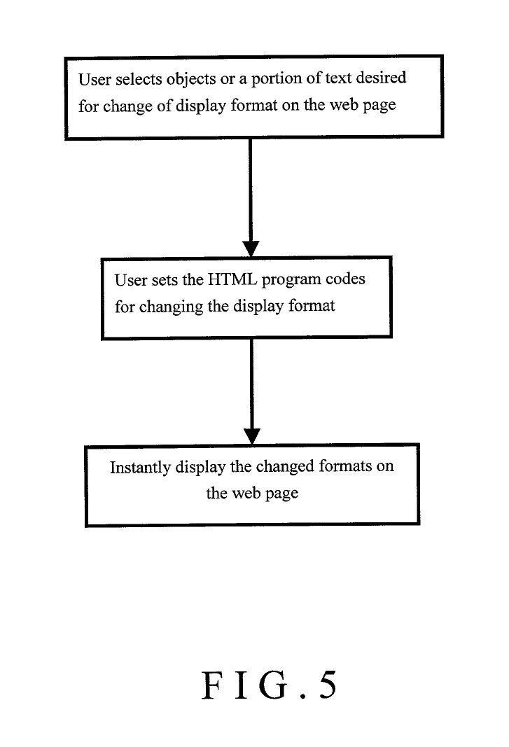

2. Change display format means (FIG. 5).

Step D: receive the reading records the user has made on the web page through the reading record function;

Step E: instant display on the web page the related reading records the user has made on the web page;

Step F: the user exits the web page;

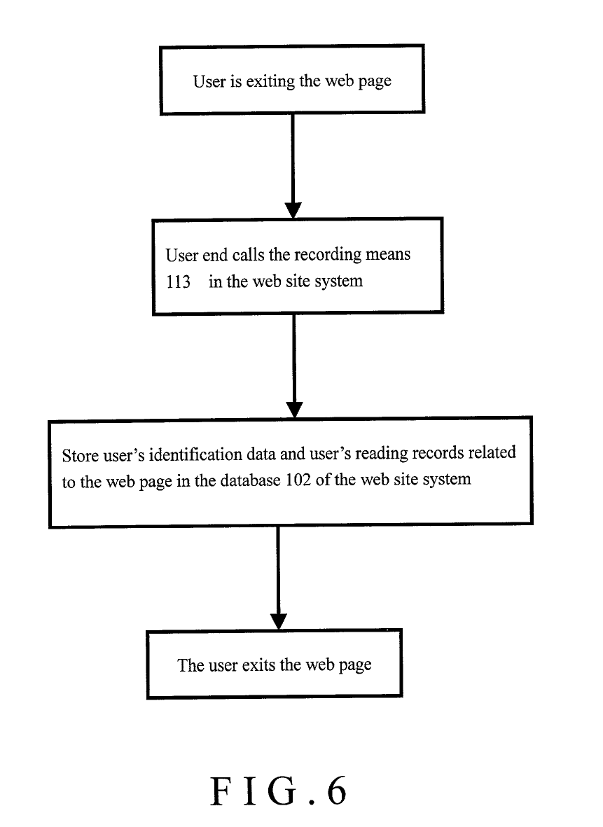

Step G: the recording means 113 stores user's identification data and reading records related to the web page made by the user in the database 102 (FIG. 6).

Referring to FIG. 4 for the processes of the insert object means of the invention, the processes include the following steps:

Step A: user 200 selects web page object positions on the web page where the desired insert objects to be located, such as utilize the mouse device to choose a spot on the web page to retrieve the object located on the spot;

Step B: the user inputs related data of the insert object: enter characters for inserting text objects;

proceed the Step C for inserting line break object;

enter file paths or hyperlink paths to the linking reference files of the inserting picture objects, audio objects, multimedia objects desired at the user end.

Step C: instantly display the inserting objects on the web page:

for inserting text objects, make a necessary HTML tag on the input text, and insert in the inner HTML attributes of the objects selected at the Step A at suitable locations;

for inserting line break object, add <BR> tag on the selected location at Step A and insert in the inner HTML attributes of the objects at the selected location;

for inserting picture objects, add <IMG> tag on the selected location at Step A and enter file path to set SRC attribute value, and insert in the inner HTML attributes of the objects at the selected location;

for inserting audio or multimedia objects, add <BUTTON> tag on the selected location at Step A and enter file path for the multimedia broadcasting means 114, and insert in the inner HTML attributes of the objects at the selected location;

for linking other reference files, add <A> tag on the selected location at Step A and enter hyperlink path to set HREF attribute value, and insert in the inner HTML attributes of the objects at the selected location.

Referring to FIG. 5 for the processes of the change display format means of the invention, the processes includes the following steps:

Step A: user 200 selects objects or a portion of text desired for change of display format on the web page, such as utilize the mouse device to choose an object or a portion of text in an object on the web page;

Step B: the user sets the HTML program codes for changing the display format:

for underlining the selected text, enter HTML program codes for <U> tag;

for adding a deletion line on the selected text, enter HTML program codes for <S> tag;

for masking the selected text, enter HTML program codes for <FONT> tag;

for masking the selected object, proceed the Step C;

for changing the format of the selected object, enter setting contents of STYLE or HTML program codes that are able to change the display format.

Step C: instantly display the changed formats on the web page:

for underlining the selected text, border the selected text with <U> tag and insert in the inner HTML attributes of the selected text object;

for adding a deletion line on the selected text, border the selected text with <S> tag and insert in the inner HTML attributes of the selected text object;

for masking the selected text, border the selected text with <FONT> tag and set <FONT STYLE=“display:none”> for the selected text, and insert in the inner HTML attributes of the selected text object;

for masking the selected object, set the selected object to obj, and set obj.style.display=none;

for changing the format of the selected object, change the set value in the STYLE and change the style attributes, or through HTML program codes to change the inner HTML attributes of the selected object.

Referring to FIG. 6 for the processes of storing user's identification data and user's reading records related to the web pages, the processes include the following steps:

Step A: when the user 200 is exiting the web page, for instance the user is leaving the web page or depresses a button to close the web page;

Step B: the user end calls the recording means 113 in the web site system 100. At the user end, close (window_onunload ()) in the web page event, utilize, for instance, Microsoft's Internet Explorer built-in Remote Data Service Object to call the recording means 113 in the web site system 100 at the user end;

Step C: store user's identification data and user's recording data related to the web page in the database 102 of the web site system 100.

User's identification data and user's recording data related to the web page (related reading record data at steps B and C shown in FIGS. 4 and 5), are transmitted to the web site system 100 through networks in parameter formats, and through the recording means 113 to store the transmitted data in the database 102. The inserting related reading records for the web page objects include: identification data for the object at the inserting location, inserting location indication, identification data and type of the inserting object, contents of the inserting object, HTML program codes required for the inserting object; identification data for the changed display format object, location indication for the changed display format, type of the changed display format, setting contents of the changed display format, HTML program codes required for the changed display format.

Step D: the user exits the web page.

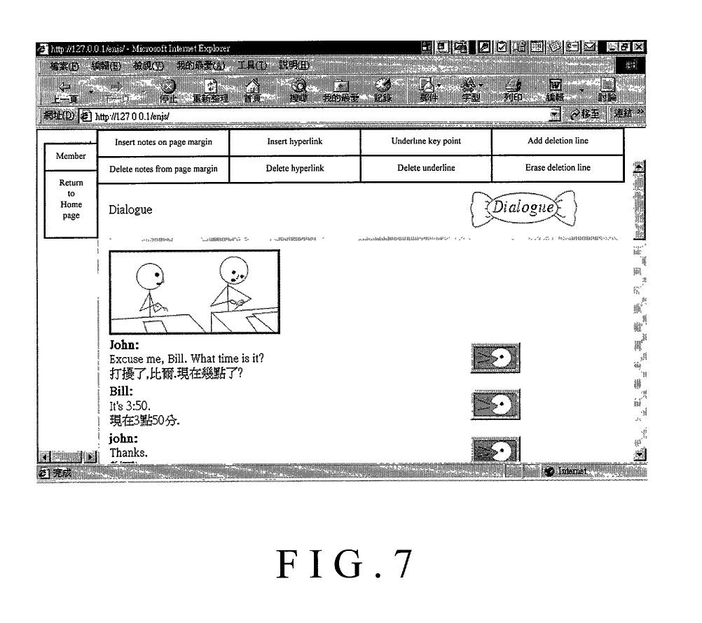

FIG. 7 illustrates an initial web page panel according to the invention.

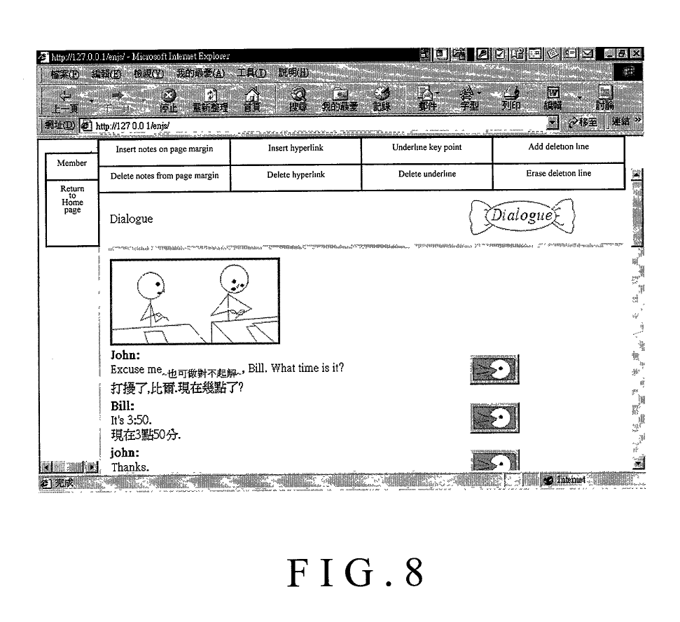

FIG. 8 shows a web page panel with a user inserting a text object to the initial web page. The user selects to insert a text object after “Excuse me” on the initial web page. The insert object means 111 will insert the input text content after “Excuse me” and immediately display on the initial web page.

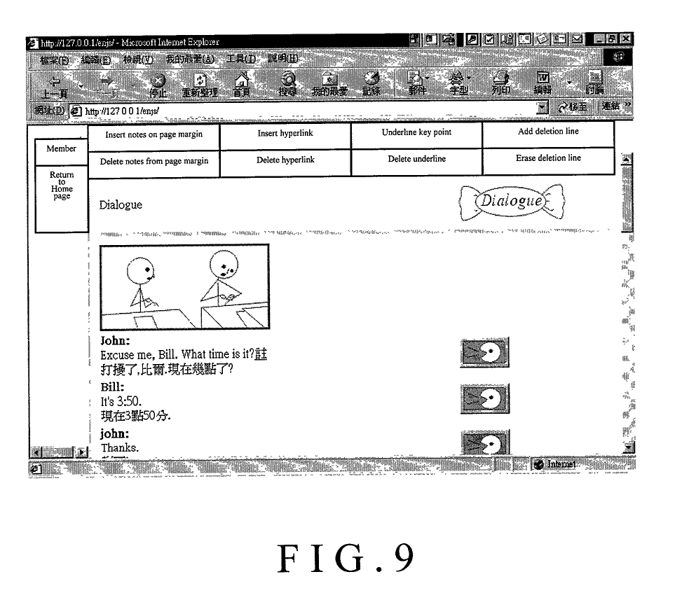

FIG. 9 shows a web page panel with a user inserting a hyperlink object to the initial web page. The user selects to insert the hyperlink object after “What time is it” on the initial web page. The insert object means 111 will insert the hyperlink object after “What time is it” and immediately display on the initial web page.

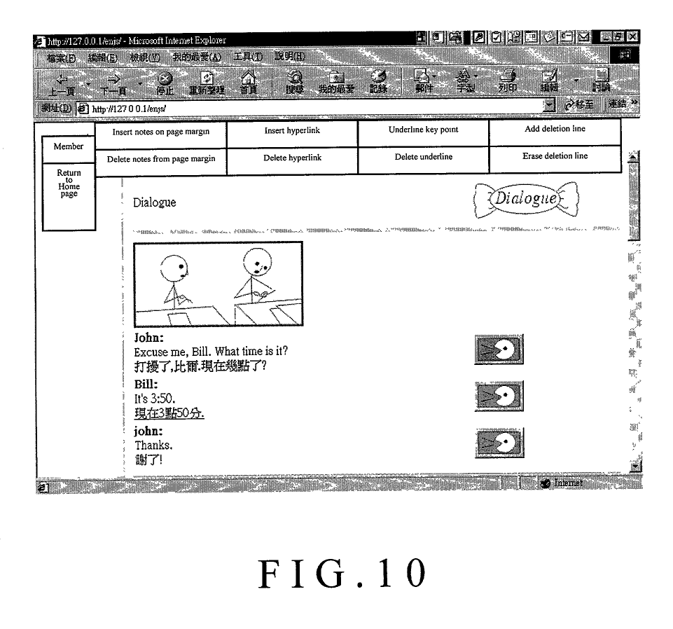

FIG. 10 shows a web page panel with a user selecting a portion of text for underlining on the initial web page. The user selects to underline the “It's 3:50” on the initial web page. The change display format means 112 will add an underline on “It's 3:50” and immediately display on the initial web page.

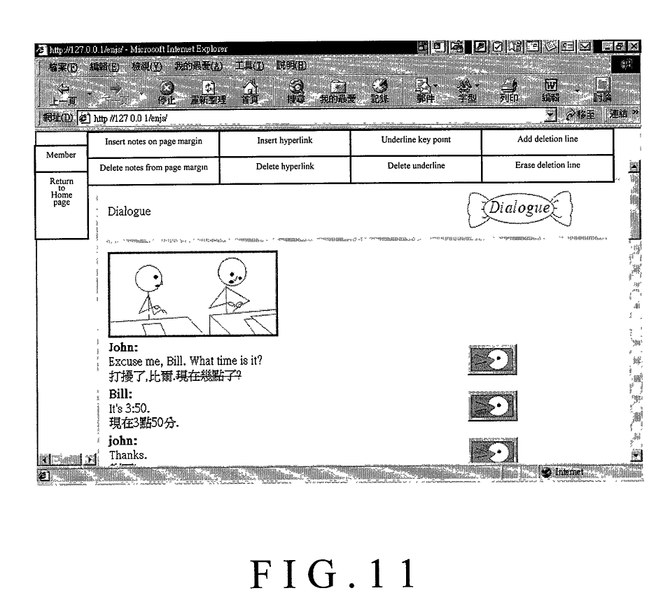

FIG. 11 shows a web page panel with a user selecting a portion of text for deletion on the initial web page. The user selects to add a deletion line on “What time is it ?” on the initial web page. The change display format means 112 will add a deletion line on “What time is it ?” and immediately display on the initial web page.

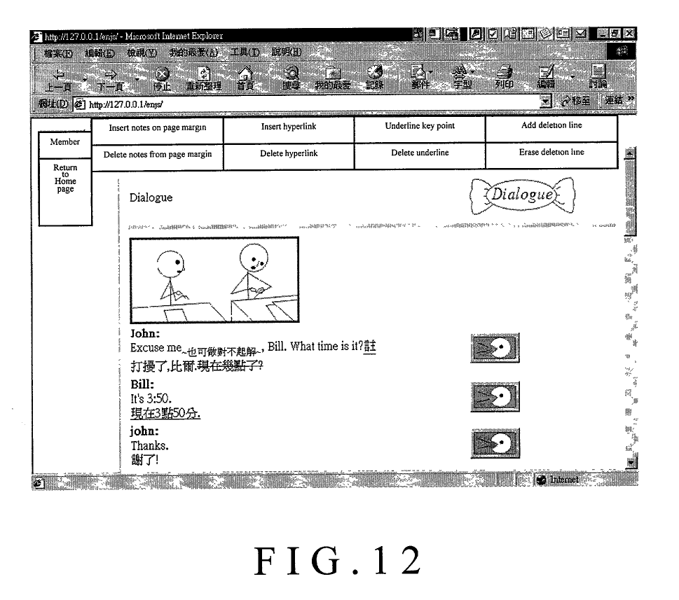

FIG. 12 shows a web page panel with the user browsing the changed initial web page. The reading records which the user has made previously on the initial web page have been stored in the database 102 through the recording means 113 when the user exited the web page. Hence when the user browses the initial web page the next time or after, all the reading records previously made will be displayed in the original formats.

The method and web site system provided by the invention allows users to enter reading records on the web pages. It is a very useful and valuable tool, especially in network education. For instance, curriculum materials (such as text, pictures, audio voice or images that can be digitized) can be transmitted through the network and presented at the client ends in web page formats for educational use. Teachers can add notes and remarks on the web page margins, underline the key points, or delete some of the contents desired. It can even be linked to teachers' complementary data. All the notes and remarks on the web page margins, underlines, or deletions will be authentically presented. Teachers can start every teaching session from the previous session with continuity and without unnecessary overlap or gap. It also can be provided to students for exercise or review use. Because the curriculum materials are transmitted through networks, teachers can add remarks and reference data to suit individual requirements. Same curriculum materials can be shared by many teachers (and with teachers' identification data to distinguish the remark sources and origins). Students can also read the contents and adding remarks on the networks. By means of the invention, distance education delivered electronically through networks becomes possible and more effective.

Moreover, the method and system of the invention may also be adapted for use in government organizations and enterprise. For instance, official or company documents may be presented in web page formats and transmitted and circulated on the networks. Superior officers or upper managers can make remarks or comments on the documents. This not only can speed up document circulation and communication, but also can help all circulating records and additional information incurred be posted with responsible persons marked for authentication. The system can also save paper and other supplies consumption, and can better conform to environmental conservation and protection.

In summary, the object, function, measures and effects of the invention are radically different from conventional techniques. It is a huge break through in the “method and system for providing online web page reading records”.

While the preferred embodiments of the invention have been set forth for purpose of disclosure, modifications of the disclosed embodiments of the invention as well as other embodiments thereof may occur to those skilled in the art. For instance, storing the reading records related to web pages is not necessarily performed at the time when the user exits the web page. When the user inserts an object or changes a portion of the display format, a Remote Data Service Object may be used to call the recording means 113 of the web site system to store the related reading records in the database 102. Accordingly, the appended claims are intended to cover all embodiments which do not depart from the spirit and scope of the invention.

What is claimed is:

1. A method for providing online web page reading records allowing a plurality of users through communication linking web pages for processing reading records, the method comprising the steps of:
displaying a web page and related reading records at a user end through a communication link, the related reading records being distinguished by user's identification data;
providing a plurality of reading record functions on the web page;
receiving reading records entered by the users through the reading records function on the web page and instantly displaying the reading records on the web page; and
storing users' identification data and the related reading records made by the users on the web page through the communication link.

2. The method of claim 1, wherein the reading record function allows the users to insert a web page object on the web page and immediately displays the inserting object on the web page.

3. The method of claim 1, wherein the reading record function provides function required for the users to change format attributes or its displaying characteristics of a selected visible object on the web page and immediately displays the changed format on the web page.

4. The method of claim 1, wherein the reading record function further includes a multimedia broadcasting function which is downloadable to user ends and accepts a practical path of a multimedia object inserting by the user and broadcasts the contents of the multimedia object.

5. The method of claim 2, wherein the inserting object can be selected from the group consisting of a text object, a picture object, an audio object, a multimedia object, a hyperlink object linking to a selected address, or a line break object for changing to the next line instantly at inserting locations on the web page.

6. The method of claim 3, wherein the function required to change format attributes or its displaying characteristics of the visible object on the web page includes adding underlines on selected texts, adding a deletion line on a selected text, masking a selected text, or masking a selected visible object.

7. The method of claim 1, wherein the web page selectively contains education materials, enterprise or government documents.

8. A web site system for providing online web page reading records allowing a plurality of users through communication linking to read contents on a web page provided by the web site system and to edit the reading records on the web page, the web site system comprising:
a server;
a database for storing a plurality of web page contents and related reading records and users' data; and
a reading record system for providing a plurality of reading record function on one web page to receive reading records related to the web page entered by a user through the reading record function and to display the reading records instantly on the web page, the reading records systems further includes a recording means to store users' identification data and the reading records related to the web page entered by the user in the database through the communication linking.

9. The web site system of claim 8, wherein the reading record system further includes an insert object means for receiving a request from the user for inserting a web page object on the web page and instantly displaying the inserting object on the web page.

10. The web site system of claim 8, wherein the reading record system further includes an change display format means for receiving a request from the user for changing a visible object format on the web page and instantly displaying the changed format on the web page.

11. The web site system of claim 9, wherein the insert object means allows the user to insert text objects, picture objects, audio objects, multimedia objects, hyperlink objects linking to selected addresses, or a line break object for changing to the next line at inserting locations on the web page.

12. The web site system of claim 10, wherein the change display format means allows users to add underlines on selected texts, to add a deletion line on a selected text, to mask a selected text, or to mask a selected visible object on the web page.

13. The web site system of claim 8, wherein the reading record system further includes a multimedia broadcasting means which is downloadable to user ends and accepts a practical path of a multimedia object inserting by the users and broadcasts contents of the multimedia object.

14. The web site system of claim 8, wherein the web page selectively contains education materials, enterprise or government documents.
